(19) United States
(12) Patent Application Publication
(10) Pub. No.: US 2026/0065790 A1
(43) Pub. Date: Mar. 5, 2026

(54) ADVANCED SENSOR INTEGRATION FOR ENHANCING AIRCRAFT TUGGING SAFETY

(71) Applicant: Rockwell Collins, Inc., Cedar Rapids, IA (US)

(72) Inventors: Suganthi Johnson, Cedar Rapids, IA (US); Gregory Crawford, Marion, IA (US)

(21) Appl. No.: 19/271,193

(22) Filed: Jul. 16, 2025

(30) Foreign Application Priority Data
Aug. 27, 2024 (IN) 202411064710

(51) Int. Cl. G08G 5/51; B64F 1/223; G08G 5/24; G08G 5/26

(52) U.S. Cl. CPC G08G 5/51; B64F 1/224; G08G 5/24; G08G 5/26

(57) ABSTRACT

A system and method for enhancing aircraft tugging safety is disclosed. The system may include a plurality of sensors mounted at various locations of an aircraft configured to sense the proximity of objects. It may also include a controller with processors to process sensor data and generate proximity information, and a proximity alert indicator with multiple proximity indication lights in vertical columns configured to activate based on the proximity information.

### CROSS-REFERENCE TO RELATED APPLICATIONS

The present application claims the benefit of India Provisional Patent Application 202411064710, filed Aug. 27, 2024, titled ADVANCED SENSOR INTEGRATION FOR ENHANCING AIRCRAFT TUGGING SAFETY, which is incorporated herein by reference in the entirety.

### TECHNICAL FIELD

The present disclosure relates generally to aircraft safety systems, and, more particularly, to displaying proximity information to tug operators for enhanced safety during aircraft tugging operations.

### BACKGROUND

Aircraft tugging operations, where an aircraft is moved on the ground by a tug vehicle, are used in the aviation industry but may present inherent safety risks due to the large size of aircraft and limited visibility for tug operators. Scenarios that can lead to costly damages include wingtip collisions with structures and wheels encountering soft ground. These incidents not only incur financial losses but also disrupt operations and compromise safety.

Conventional systems often rely solely on visual spotting by ground crew, which can be prone to human error, especially in confined spaces, adverse conditions, busy events, and night-time moves with low visibility. With no personnel in the cockpit to provide guidance, the risk of damage to aircraft remains high. The absence of real-time feedback exacerbates this challenge, as tug operators are often unaware of potential hazards until it is too late.

Therefore, there is a need for a proactive solution that can integrate multiple sensor inputs from an aircraft to provide comprehensive proximity detection and clear visual alerts to tug operators and ground crew during aircraft tugging operations. Such a system may enhance situational awareness, improve decision-making, and ultimately safeguard valuable assets while ensuring operational efficiency.

### SUMMARY

A system for enhancing aircraft tugging safety is disclosed in accordance with one or more illustrative embodiments of the present disclosure. In one illustrative embodiment, the system may include a plurality of sensors configured to be mounted at various locations of an aircraft, configured to sense the proximity of objects near these locations. In another illustrative embodiment, a controller communicatively coupled to the sensors may include one or more processors. These processors are configured to execute program instructions to receive sensor data, process this data to generate proximity information, and transmit the proximity information. In another illustrative embodiment, a proximity alert indicator comprising a housing and two or more proximity indication lights within the housing may receive the proximity information. Each of the proximity indication lights is configured to be associated with a respective location corresponding to a respective sensor and to activate based on the proximity information.

In a further aspect, the proximity alert indicator may be mounted on the nose gear of the aircraft, with the proximity indication lights facing toward the front of the aircraft. In another illustrative embodiment, the two or more proximity indication lights may be arranged in vertical columns. In another illustrative embodiment, the vertical columns may include a first vertical column and a second vertical column, aligned horizontally relative to each other. The first vertical column may be associated with locations on a first half side of the aircraft, and the second vertical column may be associated with locations on a second half side of the aircraft. In another illustrative embodiment, each vertical column may comprise four proximity indication lights.

In another illustrative embodiment, the four proximity indication lights of the first vertical column may be associated with a first-half wingtip sensing location, a first-half rudder sensing location, a first-half elevator sensing location, and a first-half gear sensing location. In another illustrative embodiment, the four proximity indication lights of the second vertical column may be associated with a second-half wingtip sensing location, a second-half rudder sensing location, a second-half elevator sensing location, and a second-half gear sensing location.

In another illustrative embodiment, the system may include a tug vehicle comprising a display configured to receive the transmitted proximity information and display a visual representation of this information. The visual representation may include indicator graphics associated with the plurality of locations on the aircraft, each providing a visual cue about the proximity of objects to its associated location.

A method for enhancing aircraft tugging safety is disclosed in accordance with one or more illustrative embodiments of the present disclosure. In one illustrative embodiment, the method may include receiving sensor data from a plurality of sensors mounted at various locations on an aircraft. In another illustrative embodiment, the sensors may be configured to sense the proximity of objects near these locations. In another illustrative embodiment, the method may involve processing the sensor data via a controller to generate proximity information. In another illustrative embodiment, the proximity information may be transmitted by the controller and received by a proximity alert indicator. In another illustrative embodiment, the proximity alert indicator may include two or more proximity indication lights within a housing, each associated with a respective sensor location.

In a further aspect, the aircraft may include the proximity alert indicator mounted on a nose gear, with the lights facing the front of the aircraft. In another aspect, the proximity indication lights may be arranged in vertical columns. In another aspect, the vertical columns may include a first vertical column aligned horizontally relative to a second vertical column. In another aspect, the first vertical column may be associated with locations on a first half side of the aircraft, while the second vertical column may be associated with locations on a second half side. In another aspect, each vertical column may include four proximity indication lights. In another aspect, the lights of the first vertical column may be associated with a first-half wingtip, rudder, elevator, and gear sensing location. In another aspect, the lights of the second vertical column may be associated with a second-half wingtip, rudder, elevator, and gear sensing location.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a conceptual block diagram of a system for enhancing aircraft tugging safety, in accordance with one or more embodiments of the present disclosure.

FIG. 2 is a side view of an aircraft equipped with a plurality of sensors, in accordance with one or more embodiments of the present disclosure.

FIG. 3 is a front view schematic of an aircraft's landing gear system, highlighting the proximity alert indicator mounted on the nose gear, in accordance with one or more embodiments of the present disclosure.

FIG. 4 is a top-down view of an aircraft in a GUI showing the plurality of locations where sensors are mounted, in accordance with one or more embodiments of the present disclosure.

FIG. 5 is a view of a GUI including a camera view of a ground engagement of wheels of landing gear of the aircraft, in accordance with one or more embodiments of the present disclosure.

FIG. 6 is a flow diagram illustrating steps performed in a method for enhancing aircraft tugging safety, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the inventive concepts disclosed herein are directed to a system and method for enhancing aircraft tugging safety through integrated sensor systems and clear visual indications. In one or more embodiments, proximity sensors are mounted at key locations on an aircraft to detect nearby objects during ground operations. The sensor data is processed by a controller to generate proximity information. This information is then used to activate visual indicator lights on a nose gear-mounted alert system, providing clear proximity warnings visible to tug operators and ground crew. The indicator lights may be arranged in vertical columns corresponding to a left side and right side of the aircraft. The system may also transmit the proximity data to a display in the tug vehicle. This integrated approach enhances situational awareness and safety during the aircraft tugging process.

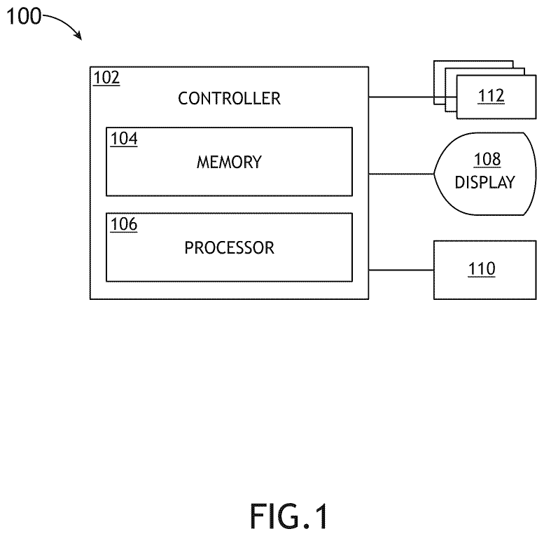

FIG. 1 illustrates a conceptual block diagram of a system 100 for enhancing aircraft tugging safety, in accordance with one or more embodiments of the present disclosure.

In embodiments, the system 100 may include a controller 102 communicatively coupled to a plurality of sensors 112. The controller 102 may include one or more processors 106. The one or more processors 106 may be configured to execute a set of program instructions stored in a memory 104. The set of program instructions may be configured to cause the one or more processors 106 to perform one or more steps of the present disclosure.

In embodiments, the system 100 may include a display 108, such as for displaying a proximity location on a tug vehicle.

In embodiments, the system 100 may include a proximity alert indicator 110, such as for alerting tug operators using lights when an obstacle is near the aircraft. The proximity alert indicator 110 may be communicatively coupled, via wire and/or wirelessly to the controller 102. For example, the communications may be used to send information on which light colors to show to the tug operator to alert the operator and avoid collisions.

The system 100 may include a plurality of sensors 112, explained in more detail below.

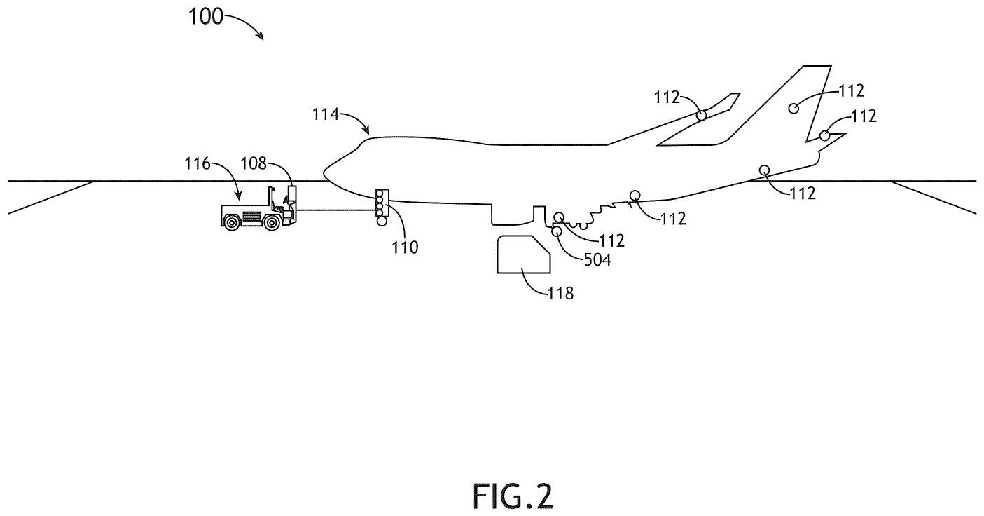

FIG. 2 illustrates a side view of an aircraft 114 equipped with a plurality of sensors 112, in accordance with one or more embodiments of the present disclosure.

The system 100 may include the aircraft 114. For example, the aircraft 114 may be manufactured with the sensors 112 built in. Alternatively, the sensors 112 may be added onto the aircraft after being manufactured.

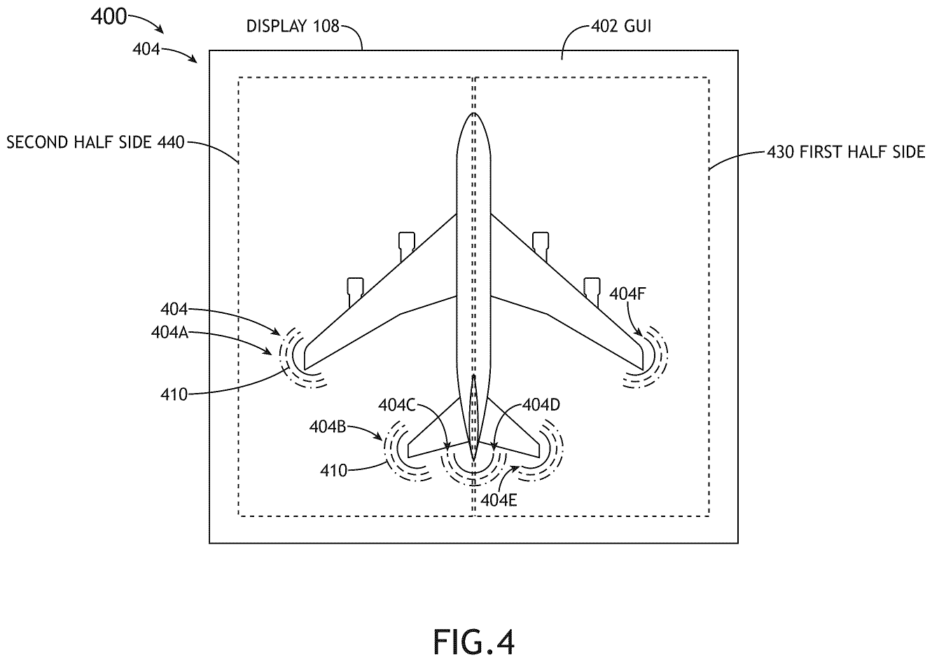

The plurality of sensors 112 may be mounted at a plurality of locations 404 (with reference to FIG. 4) of the aircraft 114. For example, the sensors 112 may be configured to be mounted to the aircraft using mounting hardware (e.g., bolts, mounting brackets, and/or the like; not shown). The plurality of sensors 112 may be configured to sense a proximity of one or more objects 118 proximate to the plurality of locations 404.

The sensors 112 may be any sensor for detecting objects 118. For example, the sensors 112 may include, but are not necessarily limited to, ultrasonic sensors and/or cameras, or the like. For cameras, camera sensor data may be processed to identify the proximity of an obstacle 118, such as using machine learning models trained to identify objects on an airport runway or other locations at an airport. Note that the system 100 may include cameras only, ultrasonics only, or both. Note that any other proximity sensor may likewise be used.

The system 100 may include a tug vehicle 116 configured to tug an aircraft 114. For example, the system 100 may include a display 108 on the tug vehicle 116 configured to indicate when objects 118 are close and to alert the tug operator. For instance, the display 108 may be communicatively coupled, via wire and/or wirelessly, to the controller 102.

As shown, the aircraft 114 may include the proximity alert indicator 110. The proximity alert indicator 110 may be configured to be mounted on a nose gear of the aircraft 114.

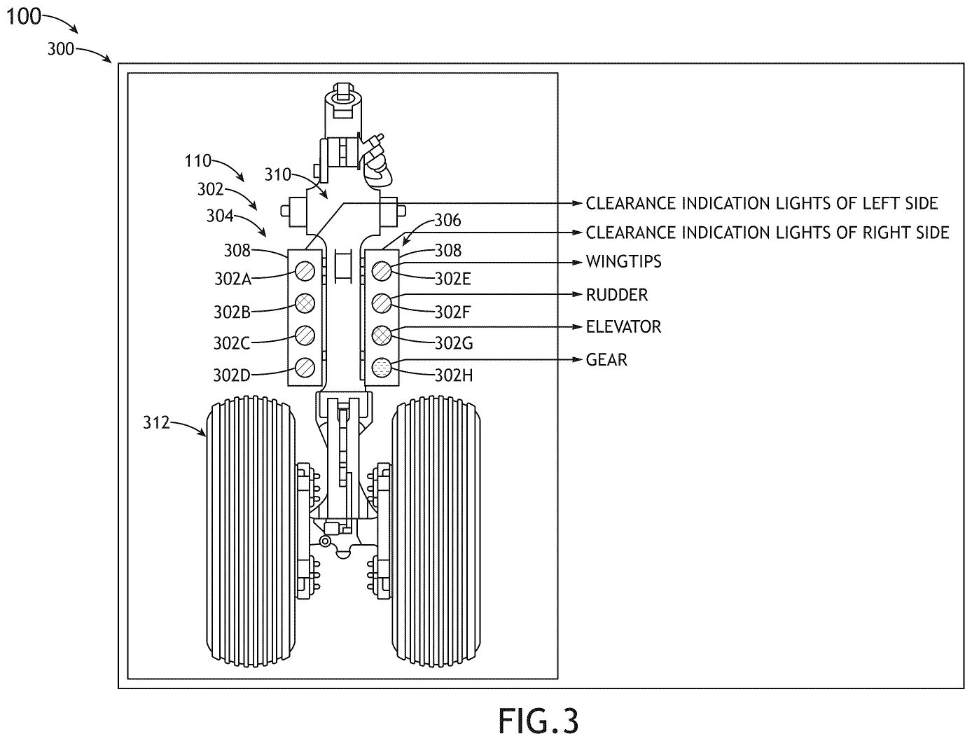

FIG. 3 illustrates a front view schematic 300 of an aircraft's landing gear system 310, 312, highlighting a proximity alert indicator 110 mounted on the nose gear 310, in accordance with one or more embodiments of the present disclosure.

As noted, the system 100 may include a proximity alert indicator 110. The proximity alert indicator 110 may include two or more proximity indication lights 302.

In embodiments, the proximity alert indicator 110 comprises the two or more proximity indication lights 302, which are arranged in two vertical columns 304, 306.

The proximity alert indicator 110 may include a housing 308. For example, the housing 308 may be one or more box shapes. For example, the housing 308 may be configured to be mounted to a nose gear 310 of the aircraft 114. For instance, as shown, the housing 308 may include two housing vertical members configured to mount to each side of a vertical nose gear member of the nose gear 310. Each housing vertical member may comprise four proximity indication lights 302.

The proximity alert indicator 110 may be configured to receive the proximity information and to perform an activating of at least one of the two or more proximity indication lights 302 based on the proximity information. At least for purposes of the present disclosure, “activating” may include changing color as well as turning on a light. For example, two green-colored proximity indication lights 302 may be activated to be yellow if those proximity indication lights 302 are associated with two detections of an obstacle 118.

The two or more proximity indication lights 302 may be located within the housing 308. Each of the two or more proximity indication lights 302 may be configured to be associated with a respective location of the plurality of locations 404 corresponding to a respective sensor of the plurality of sensors 112.

The two or more proximity indication lights 302 may be configured to face toward a front (i.e., nose of FIG. 4) of the aircraft 114. This allows the tug operator to see the proximity indication lights 302. The proximity indication lights 302 may be powered in any way, such as via a battery and/or via wired power from the aircraft, from the tug vehicle, and/or the like.

As noted, the two or more proximity indication lights 302 may be arranged in vertical columns 304, 306.

The vertical columns 304, 306 may include a first vertical column 304 aligned horizontally relative to a second vertical column 306. The first vertical column 304 may be associated with locations 404 of a first half side 430 of the aircraft 114. The second vertical column 306 may be associated with locations 404 of a second half side 440 of the aircraft 114. For example, the first half side 430 and the second half side 440 may be the right side and left side, respectively, of the aircraft 114, or vice versa. See FIG. 4 for an example of a first half side 430 and a second half side 440.

The first vertical column 304 and the second vertical column 306 may each include four respective proximity indication lights 302. Each proximity indication light 302 may be configured to light up with a specific color when a respective sensor 112 detects an obstacle.

The four proximity indication lights 302A, 302B, 302C, 302D of the first vertical column 304 may be associated with, respectively, in reference to FIG. 4, the locations 404 of: a first-half wingtip sensing location 404F, a first-half rudder sensing location 404D, a first-half elevator sensing location 404E, and a first-half gear sensing location (not shown). For example, a vertical order from top to bottom may be: a first-half wingtip proximity indication light 302A, a first-half rudder proximity indication light 302B, a first-half elevator proximity indication light 302C, and a first-half (landing) gear proximity indication light 302D. For instance, the same vertical order, but for the second half side 440 may be used for the four proximity indication lights 302E, 302F, 302G, 302H of the second vertical column 306. For instance, the four proximity indication lights 302E, 302F, 302G, 302H of the second vertical column 306 may be associated with, respectively, the plurality of locations 404 of: a second-half wingtip sensing location 404A, a second-half rudder sensing location 404C, a second-half elevator sensing location 404B, and a second-half (landing) gear sensing location (not shown). For example, a vertical order from top to bottom may be: a second-half wingtip proximity indication light 302E, a second-half rudder proximity indication light 302F, a second-half elevator proximity indication light 302G, and a second-half (landing) gear proximity indication light 302H.

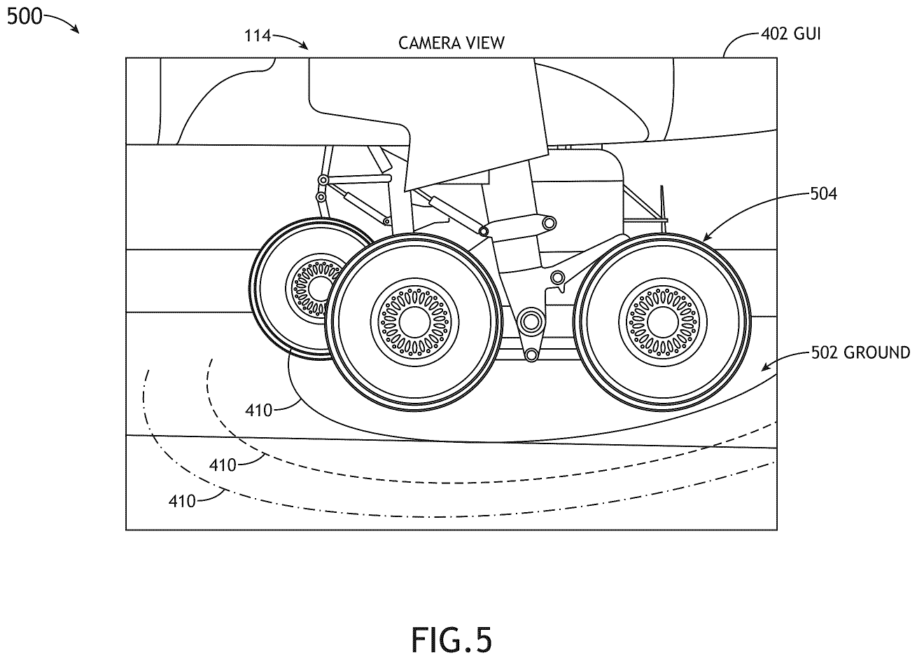

Note that the locations 404 of the first-half (landing) gear proximity indication light 302D and the second-half (landing) gear proximity indication light 302H may be proximate to landing gear near the rear (i.e., non-nose gear) on the first side 430 and second side 440, respectively, of the aircraft 114. For example, wheel 504 of FIG. 5 is part of either the first 430 or second 440 side of such rear-located landing gear. In this way, rear landing gear 504 farther away from the tug operator may be monitored.

In an example embodiment, the proximity alert indicator 110 may be configured to activate/change a color of color-coded proximity indication lights 302 to indicate different levels of proximity. For instance, green may indicate ample clearance, amber may indicate caution, and red may indicate a likely collision, based on distance to the obstacle 118. This color-coding scheme enhances the intuitiveness of the alerts for tug operators.

For instance, the color may be based on one or more thresholds. For instance, a first threshold (e.g., 40 feet or less) may be used, where an obstacle 118 inside the first threshold is configured to cause a proximity indication light 302 to change from green to yellow. For instance, in addition, a second threshold (e.g., 20 feet or less) may be used, where an obstacle 118 inside the second threshold is configured to cause a proximity indication light 302 to change from yellow to red.

FIG. 4 illustrates a top-down view 400 of an aircraft 114 showing the plurality of locations 404 where sensors 112 are mounted, in accordance with one or more embodiments of the present disclosure. The figure illustrates specific sensing locations including the first-half wingtip sensing location 404F, second-half wingtip sensing location 404A, first-half rudder sensing location 404D, second-half rudder sensing location 404C, first-half elevator sensing location 404E, and second-half elevator sensing location 404B.

As described earlier in reference to FIG. 2, the system 100 may include a tug vehicle 116. The tug vehicle 116 may include a display 108. The display 108 may be configured to receive the transmitted proximity information.

Referring back to FIG. 4, the display 108 may be configured to display to a user a graphical user interface (GUI) 402. The GUI 402 may be configured to display to a user anything shown in FIG. 4 and/or FIG. 5, but is not necessarily limited to such things.

The display 108 may be configured to display a visual representation of the proximity information. The visual representation may include indicator graphics 410 associated with the plurality of locations 404 on the aircraft 114. Each indicator graphic 410 may provide a visual cue about the proximity of objects 118 to its associated location 404.

The GUI 402 may include a graphical symbol of the aircraft 114, such as is shown.

In embodiments, the indicator graphics 410 (i.e., proximity indicator graphics) may be color-coded graphic symbols near corresponding locations 404 (e.g., wingtips, rudder, elevation, rear landing gear) of the aircraft 114 where the sensors 112 are located. For example, the color-coded graphic symbols 410 may be one or more curved lines emanating from the locations 404. For example, the graphic symbols 410 may be red, yellow, or green lines, depending on the sensed proximity of an obstacle 118. For instance, the choice in color may be based on one or more thresholds. For instance, a first threshold (e.g., 40 feet or less) may be used, where an obstacle 118 inside the first threshold is configured to cause the GUI 402 to change a graphic symbol 410 from green to yellow. For instance, in addition, a second threshold (e.g., 20 feet or less) may be used, where an obstacle 118 inside the second threshold is configured to cause the GUI 402 to change a graphic symbol 410 from yellow to red.

Note that these same color changes and first and second thresholds may be configured to be used to activate (e.g., change color) of the proximity indication lights 302 of FIG. 3 from green to yellow to red, or the like.

FIG. 5 illustrates a view 500 of a GUI 402 including a camera view 500 of a ground engagement of wheels 312 of landing gear of the aircraft 114, in accordance with one or more embodiments of the present disclosure.

In embodiments, the aircraft 114 may be equipped with downward-facing cameras 112 near the rear landing gear and configured to provide a view of the ground surface condition of the ground 502. This information may be configured to be processed by the controller 102 and displayed on the GUI 402 as an alert to alert the tug operator of potential hazards like soft or uneven terrain.

In embodiments, the GUI 402 may be configured to display an output of a camera view of a sensor 112 that is a camera, such as a camera pointing at the rear landing gear 504. The GUI 402 may be configured to superimpose graphic symbols 410 around the rear landing gear 504 based on at least one of: a proximity to an obstacle or a detection of at least one of soft or uneven terrain. For instance, machine learning models may be trained on terrain data to identify soft or uneven terrain. Such an embodiment may allow for preventing the wheels from getting stuck in muddy, soft soil rather than staying on concrete or pavement.

Note that such a detection of soft ground may, likewise, be configured to activate the first and second half gear proximity indication lights 302D, 302H. For example, the first and second half gear proximity indication lights 302D, 302H may be configured to change color based on at least one of: a proximity to an obstacle or a detection of at least one of soft or uneven terrain. For example, the first and second half gear proximity indication lights 302D, 302H may be configured to be activated based on both a proximity to an obstacle and a detection of at least one of soft or uneven terrain.

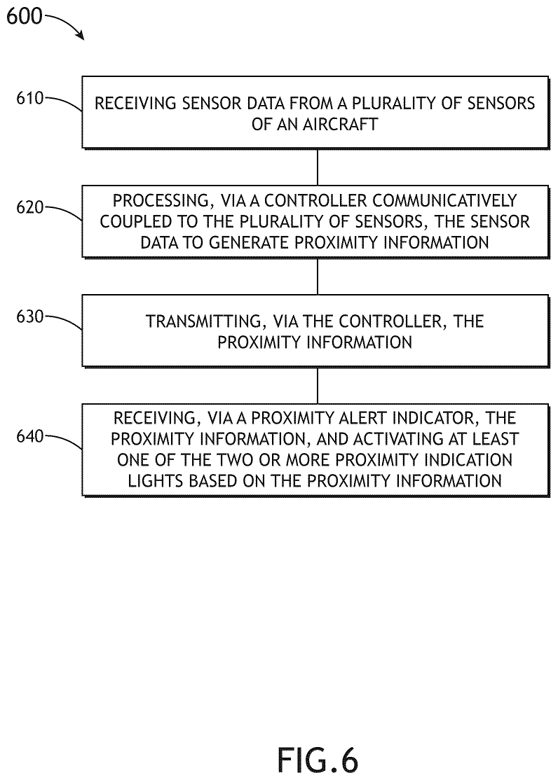

FIG. 6 illustrates a flow diagram illustrating steps performed in a method 600 for enhancing aircraft tugging safety, in accordance with one or more embodiments of the present disclosure. It is noted that the embodiments and enabling technologies described previously herein in the context of the system 100 should be interpreted to extend to the method 600. It is further noted herein that the steps of method 600 may be implemented all or in part by system 100. It is further recognized, however, that the method 600 is not limited to the system 100 in that additional or alternative system-level embodiments may carry out all or part of the steps of method 600.

At step 610, sensor data from a plurality of sensors 112 of an aircraft 114 is received. For example, the sensor data may be computer data stored in memory 104, such as data acquired from sensors 112. For instance, the sensor data may include camera image data, ultrasonic data, distance-to-obstacle data, and/or the like.

At step 620, the sensor data is processed to generate proximity information. For example, the ultrasonic data may be a difference in time that ultrasonic waves were sent and then sensed after reflection off of an obstacle 118. This time difference may be processed using an equation based on a speed of sound in ambient air to calculate a distance to the obstacle 118. Alternatively, image data may be processed by a machine learning algorithm, or the like, such as YOLO, to detect, in real time, a location and therefore a distance to an obstacle 118. Note that these are examples and the processing may include any processing, such as reformatting the data for sending as a transmission, and/or the like. The processing may be performed by controller 102. The processing may include determining whether one or more thresholds have been breached as described above.

At step 630, the proximity information is transmitted. For example, the controller 102 may be configured to direct the proximity information to be transmitted by wire or wirelessly. For instance, the controller 102 may be configured to direct the proximity information to be transmitted by an antenna (not shown).

At step 640, the proximity information is received by a proximity alert indicator 110 and the proximity alert indicator 110 activates (e.g., changes color) of at least one of two or more proximity indication lights 302 based on the proximity information. For instance, the proximity information may be an electrical signal configured to be received by a color controller of the proximity alert indicator 110 and configured to change the color of a particular proximity indication light 302, such as changing the first-half rudder proximity indication light 302B from green to yellow. This may correspond to an obstacle 118 approaching the first-half rudder location 404D.

In embodiments, the proposed integration of sensor and camera technology onto aircraft and use of a housing on nose gear with proximity indication lights represents a proactive approach to tugging safety. By equipping tug operators with real-time data and visual feedback, the system empowers them to navigate challenging environments with confidence and precision. Ultimately, the present disclosure not only safeguards valuable assets but may also promote operational efficiency and safety across the aviation industry.

The one or more processors 106 of controller 102 may include any one or more processing elements known in the art. In this sense, the one or more processors 106 may include any microprocessor device configured to execute algorithms and/or instructions. In one embodiment, the one or more processors 106 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium (e.g., memory 104). Moreover, different subsystems of the system 100 may include processor or logic elements suitable for carrying out at least a portion of the steps described throughout the present disclosure. Therefore, the above description should not be interpreted as a limitation on the present invention but merely an illustration.

The memory medium 104 may include any storage medium known in the art suitable for storing program instructions executable by the associated one or more processors 106. For example, the memory medium 104 may include a non-transitory memory medium. For instance, the memory medium 104 may include, but is not limited to, a read-only memory, a random access memory, a magnetic or optical memory device (e.g., disk), a magnetic tape, a solid state drive and the like. In another embodiment, it is noted herein that the memory 104 is configured to store one or more results from the system 100 and/or the output of the various steps described herein. It is further noted that memory 104 may be housed in a common controller housing with the one or more processors 106. In an alternative embodiment, the memory 104 may be located remotely with respect to the physical location of the processors and controller 102. For instance, the one or more processors 106 of controller 102 may access a remote memory (e.g., server), accessible through a network (e.g., internet, intranet and the like). In another embodiment, the memory medium 104 stores the program instructions for causing the one or more processors 106 to carry out the various steps described through the present disclosure.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

In another embodiment, the controller 102 of the system 100 may be configured to receive and/or acquire data or information from other systems by a transmission medium that may include wireline and/or wireless portions. In another embodiment, the controller 102 of the system 100 may be configured to transmit data or information (e.g., the output of one or more processes disclosed herein) to one or more systems or sub-systems by a transmission medium that may include wireline and/or wireless portions. In this manner, the transmission medium may serve as a data link between the controller 102 and other subsystems of the system 100. Moreover, the controller 102 may send data to external systems via a transmission medium (e.g., network connection).

In another embodiment, the system 100 includes a user interface. In one embodiment, the user interface is communicatively coupled to the one or more processors 106 of controller 102. In another embodiment, the user interface device may be utilized by controller 102 to accept selections and/or instructions from a user. In some embodiments, described further herein, a display may be used to display data to a user (not shown). In turn, a user may input, via user input device, a selection and/or instructions responsive to data displayed to the user via the display device.

The user interface device may include any user interface known in the art. For example, the user input device of the user interface may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device or the like. In the case of a touchscreen interface device, those skilled in the art should recognize that a large number of touchscreen interface devices may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

The display device 108 may include any display device known in the art. In one embodiment, the display device 108 may include, but is not limited to, a liquid crystal display (LCD). In another embodiment, the display device may include, but is not limited to, an organic light-emitting diode (OLED) based display. In another embodiment, the display device may include, but is not limited to a CRT display. Those skilled in the art should recognize that a variety of display devices may be suitable for implementation in the present invention and the particular choice of display device may depend on a variety of factors, including, but not limited to, form factor, cost, and the like. In a general sense, any display device capable of integration with a user input device (e.g., touchscreen, bezel mounted interface, keyboard, mouse, trackpad, and the like) is suitable for implementation in the present invention.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system for enhancing aircraft tugging safety, the system comprising:
a plurality of sensors configured to be mounted at a plurality of locations of an aircraft and configured to sense a proximity of one or more objects proximate to the plurality of locations;
a controller communicatively coupled to the plurality of sensors, wherein the controller comprises one or more processors configured to execute a set of program instructions stored in a memory, the set of program instructions configured to cause the one or more processors to:
receive sensor data from the plurality of sensors;
process the sensor data to generate proximity information; and
transmit the proximity information; and
a proximity alert indicator comprising two or more proximity indication lights, wherein the proximity alert indicator is configured to receive the proximity information and to perform an activating of at least one of the two or more proximity indication lights based on the proximity information, wherein the proximity alert indicator comprises:
a housing; and
the two or more proximity indication lights located within the housing, wherein each of the two or more proximity indication lights is configured to be associated with a respective location of the plurality of locations corresponding to a respective sensor of the plurality of sensors.

2. The system of claim 1,
wherein the proximity alert indicator is configured to be mounted on a nose gear of the aircraft and the two or more proximity indication lights are configured to face toward a front of the aircraft.

3. The system of claim 2,
wherein the two or more proximity indication lights are arranged in vertical columns.

4. The system of claim 3,
wherein the vertical columns comprise a first vertical column aligned horizontally relative to a second vertical column; wherein the first vertical column is associated with locations of a first half side of the aircraft and wherein the second vertical column is associated with locations of a second half side of the aircraft.

5. The system of claim 4,
wherein the first vertical column and the second vertical column each, respectively, comprise four proximity indication lights.

6. The system of claim 5,
wherein the four proximity indication lights of the first vertical column are associated with, respectively, the plurality of locations comprising:
a first-half wingtip sensing location;
a first-half rudder sensing location;
a first-half elevator sensing location; and
a first-half gear sensing location.

7. The system of claim 6,
wherein the four proximity indication lights of the second vertical column are associated with, respectively, the plurality of locations comprising:
a second-half wingtip sensing location;
a second-half rudder sensing location;
a second-half elevator sensing location; and
a second-half gear sensing location.

8. A system for enhancing aircraft tugging safety, the system comprising:
a plurality of sensors configured to be mounted at a plurality of locations of an aircraft and configured to sense a proximity of one or more objects proximate to the plurality of locations;
a controller communicatively coupled to the plurality of sensors, wherein the controller comprises one or more processors configured to execute a set of program instructions stored in a memory, the set of program instructions configured to cause the one or more processors to:
receive sensor data from the plurality of sensors;
process the sensor data to generate proximity information; and
transmit the proximity information; and
a tug vehicle comprising a display, wherein the display is configured to:
receive the transmitted proximity information; and
display a visual representation of the proximity information, wherein the visual representation includes indicator graphics associated with the plurality of locations on the aircraft, each indicator graphic providing a visual cue about the proximity of objects to its associated location.

9. The system of claim 8, further comprising:
a proximity alert indicator comprising two or more proximity indication lights, wherein the proximity alert indicator is configured to receive the proximity information and to perform an activating of at least one of the two or more proximity indication lights based on the proximity information, wherein the proximity alert indicator comprises:
a housing; and
the two or more proximity indication lights located within the housing, wherein each of the two or more proximity indication lights is configured to be associated with a respective location of the plurality of locations corresponding to a respective sensor of the plurality of sensors.

10. The system of claim 9,
wherein the aircraft comprises the proximity alert indicator and wherein the proximity alert indicator is configured to be mounted on a nose gear of the aircraft and the two or more proximity indication lights are configured to face toward a front of the aircraft.

11. The system of claim 10,
wherein the two or more proximity indication lights are arranged in vertical columns.

12. The system of claim 11,
wherein the vertical columns comprise a first vertical column aligned horizontally relative to a second vertical column; wherein the first vertical column is associated with locations of a first half side of the aircraft and wherein the second vertical column is associated with locations of a second half side of the aircraft.

13. The system of claim 12,
wherein the first vertical column and the second vertical column each comprise four proximity indication lights.

14. The system of claim 13,
wherein the four proximity indication lights of the first vertical column are associated with, respectively, the plurality of locations comprising:
a first-half wingtip sensing location;
a first-half rudder sensing location;
a first-half elevator sensing location; and
a first-half gear sensing location.

15. The system of claim 14,
wherein the four proximity indication lights of the second vertical column are associated with, respectively, the plurality of locations comprising:
a second-half wingtip sensing location;
a second-half rudder sensing location;
a second-half elevator sensing location; and
a second-half gear sensing location.

16. A method for enhancing aircraft tugging safety, the method comprising:
receiving sensor data from a plurality of sensors, wherein the plurality of sensors are mounted at a plurality of locations of an aircraft and configured to sense a proximity of one or more objects proximate to the plurality of locations;
processing, via a controller communicatively coupled to the plurality of sensors, the sensor data to generate proximity information;
transmitting, via the controller, the proximity information; and
receiving, via a proximity alert indicator, the proximity information, wherein the proximity alert indicator comprises two or more proximity indication lights, wherein the proximity alert indicator is configured to perform an activating of at least one of the two or more proximity indication lights based on the proximity information, wherein the proximity alert indicator comprises:
a housing; and
the two or more proximity indication lights located within the housing, wherein each of the two or more proximity indication lights is configured to be associated with a respective location of the plurality of locations corresponding to a respective sensor of the plurality of sensors.

17. The method of claim 16,
wherein the proximity alert indicator is configured to be mounted on a nose gear of the aircraft and the two or more proximity indication lights are configured to face toward a front of the aircraft.

18. The method of claim 17,
wherein the two or more proximity indication lights are arranged in vertical columns.

19. The method of claim 18,
wherein the vertical columns comprise a first vertical column aligned horizontally relative to a second vertical column; wherein the first vertical column is associated with locations of a first half side of the aircraft and wherein the second vertical column is associated with locations of a second half side of the aircraft.

20. The method of claim 19,
wherein the first vertical column and the second vertical column each, respectively, comprise four proximity indication lights,
wherein the four proximity indication lights of the first vertical column are associated with, respectively, the plurality of locations comprising:
a first-half wingtip sensing location;
a first-half rudder sensing location;
a first-half elevator sensing location; and
a first-half gear sensing location,
wherein the four proximity indication lights of the second vertical column are associated with, respectively, the plurality of locations comprising:
a second-half wingtip sensing location;
a second-half rudder sensing location;
a second-half elevator sensing location; and
a second-half gear sensing location.
